(19) United States
(12) Patent Application Publication
(10) Pub. No.: US 2009/0206568 A1
(43) Pub. Date: Aug. 20, 2009

(54) CARRIER FOR GOLFBAG

(76) Inventor: Seung Ho Lee, Seoul (KR)

Correspondence Address: IPLA P.A., 3580 WILSHIRE BLVD., 17TH FLOOR, LOS ANGELES, CA, 90010, US

(21) Appl. No.: 12/279,487

(22) PCT Filed: Feb. 12, 2007
(86) PCT No.: PCT/KR2007/000742

§ 371 Date: Aug. 14, 2008

(30) Foreign Application Priority Data
Feb. 15, 2006 (KR) 20-2006-0004274

(51) Int. Cl. B62B 1/26

(52) U.S. Cl. 280/47.26

(57) ABSTRACT

A carrier for a golf bag is disclosed, which comprises a mounting unit which has a mounting rim for mounting a lower side of a golf bag, a mounting member at a lower surface of the mounting rim, and a upright member formed at a front surface of the mounting member; a support unit which is connected with both sides of a back surface of the mounting member, thus being connected with a support member and has a handle formed by connecting with an end by bending an upper side of the support member to be parallel with the ground and has a connection member for connecting each support member at a bent portion of the support member and an engaging ring at a center of the connection member; a fixing ring which is formed at an upper front side of the support member of the support unit; and a driving unit which has a driving shaft at a lower side of the support unit of the support unit and driving wheels having bearings at an outer diameter portion of the driving shaft.

### TECHNICAL FIELD

The present invention relates to a carrier for a golf bag.

### BACKGROUND ART

The present invention relates to a carrier for a golf bag, and in particular to a carrier for a golf bag which stores a golf club, and it is possible to easily move a golf bag and a Boston bag, and it is possible to easily store and move the golf bag and Boston bag. The intervals of wheels can be easily adjusted so that the carrier can be easily moved in a field.

Generally, a golfer uses a golf bag for storing a plurality of golf clubs or gold items.

Since the golf bag stores various woods and irons and T-shaped, L-shaped and half moon shaped putters and various golf items, the weights are too heavy for women, weak persons and adult persons to move the same.

So as to move the golf club, each golfer carries various golf bags or the golf bags are moved using a cart. In this case, since each golfer is needed to move his golf bag from the vehicle to a place where the carts are provided, so that the golfers may have big burdens on their shoulders.

So as to overcome the above problems, according to the Korean patent registration and application No. 106665, a carrier for a golf bag is disclosed. In the above carrier for a golf bag, a pair of connection members are formed at both sides of a mounting piece which is designed to mount a lower end of the golf bag, and an adjusting member is formed at an outer side of the connection member. The angle of a support part having driving wheels which move or support the carrier for a golf bag is adjusted.

However, in the above carrier for a golf bag, it is not easy to control the angle of the support part owing to the weight of the golf bag mounted in a mounting piece, and it is designed to move only the golf bag. So, the Boston bag should be carried with hands. Since the carrier is not provided with a certain member for fixing then golf bag, the golf bag may fall down.

So as to move the carrier for a golf bag in the indoor, since it is moved with a handle, carrying the carrier in the indoor is not easy.

### DISCLOSURE OF INVENTION

### Technical Problem

Accordingly, it is an object of the present invention to provide a carrier for a golf bag which overcomes the problems encountered in the conventional art.

It is another object of the present invention to provide a carrier for a golf bag in which it is possible to concurrently move a golf bag, which stores golf clubs, and a Boston bag and to prevent the golf bag from falling down or escaping. The carrier can be pushed and moved in the indoor.

To achieve the above objects, there is provided a carrier for a golf bag, which comprises a mounting unit which has a mounting rim for mounting a lower side of a golf bag, a mounting member at a lower surface of the mounting rim, and a upright member formed at a front surface of the mounting member; a support unit which is connected with both sides of a back surface of the mounting member, thus being connected with a support member and has a handle formed by connecting with an end by bending an upper side of the support member to be parallel with the ground and has a connection member for connecting each support member at a bent portion of the support member and an engaging ring at a center of the connection member; a fixing ring which is formed at an upper front side of the support member of the support unit; and a driving unit which has a driving shaft at a lower side of the support unit of the support unit and driving wheels having bearings at an outer diameter portion of the driving shaft.

The handle of the support unit has a moving hole at the handle member, and a fixture which is elastically installed at an inner side of the handle member for thus moving along the moving hole with a spring being disposed, with a fixing protrusion, which has a fixing groove, being formed at an end of the support member so that the fixture is fixedly inserted, and being inserted into the handle member.

The handle is inserted into the support member, and a fixing ball elastically protruded from the handle is provided, and a fixing hole is formed at the support member.

### ADVANTAGEOUS EFFECTS

In the driving unit, a pair of driving shafts are inserted into the support member, and an elastic spring is formed at an installation groove formed at a center end of the driving shaft, and a stop ball is formed at an upper side of the elastic spring, and there is provided a connection rod having a fixing hole into which a center end of the driving shaft and the stop ball are inserted, respectively, and a buffering spring is elastically inserted into an inner side of the driving shaft.

### BRIEF DESCRIPTION OF THE DRAWINGS

The present invention will become better understood with reference to the accompanying drawings which are given only by way of illustration and thus are not limitative of the present invention, wherein

FIG. 1 is a perspective view illustrating a carrier for a golf bag according to the present invention;

FIG. 2 is a lateral view illustrating a carrier for a golf bag according to the present invention;

FIG. 3 is a front view illustrating a carrier for a golf bag according to the present invention;

FIG. 4 is a cross sectional view illustrating a handle of a carrier for a golf bag according to the present invention;

FIG. 5 is a partial perspective view illustrating a handle of a carrier for a golf bag according to another embodiment of the present invention;

FIG. 6 is a cross sectional view illustrating a driving unit of a carrier for a golf bag according to another embodiment of the present invention;

FIG. 7 is a perspective view illustrating a mounting part of a carrier for a golf bag according to another embodiment of the present invention; and

FIG. 8 is a view of a state of a carrier for a golf bag according to the present invention.

### BEST MODE FOR CARRYING OUT THE INVENTION

The preferred embodiments of the present invention will be described with reference to the accompanying drawings.

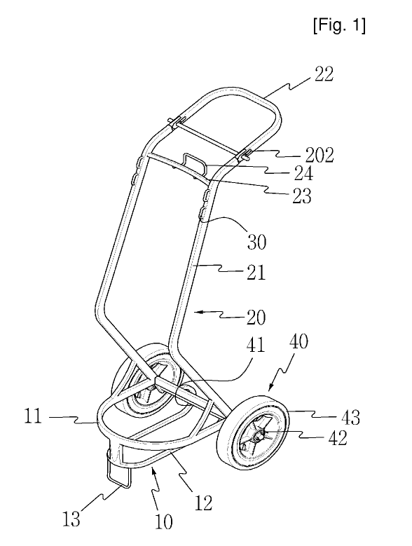

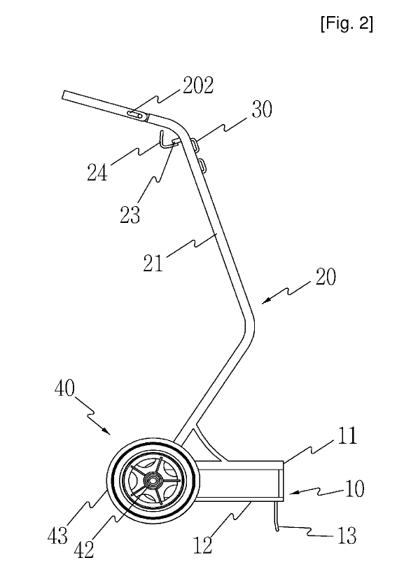

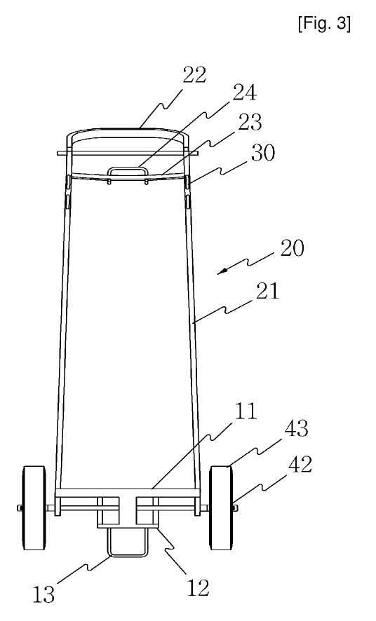

FIG. 1 is a perspective view illustrating a carrier for a golf bag according to the present invention. FIG. 2 is a lateral view illustrating a carrier for a golf bag according to the present invention. FIG. 3 is a front view illustrating a carrier for a golf bag according to the present invention.

The carrier for a golf bag according to the present invention comprises a mounting part 10 for mounting a golf bag thereon which stores golf clubs.

The mounting part 10 includes a mounting rim 11 for mounting a lower side of the golf bag B. A mounting member 12 is formed at a lower side of the mounting rim 11 for supporting the lower surface of the golf bag B. An upright part 13 is formed at a front side of the mounting member 12, so that the carrier for a golf bag keeps upright.

A support part 20 is formed at both sides of a back surface of the mounting part 10.

The support unit 20 is connected with the support member 21 for a connection with the mounting rim 11, and a handle 22 is formed by bending the upper end of the support member 21 and making the same be parallel with the ground. A connection member 23, which connects each support member 21, is formed at a bent portion of the support member 21, and a ring 24 is formed at a center of the connection member 23.

The support member 21 of the support unit 20 surrounds the lateral side of the golf bag B and is slanted at a certain angle for keeping the golf bag B being slanted at a certain angle.

A fixing ring 30 is formed at a front upper side of the support member 21 of the support unit 20.

A driving unit 40 is formed at a lower side of the support member 20 of the support unit 20 for thereby moving the carrier for a golf bag.

The driving unit 40 is provided with a driving shaft 41 and driving wheels 43 having bearings 42 at outer diameter portions of the driving shaft 41.

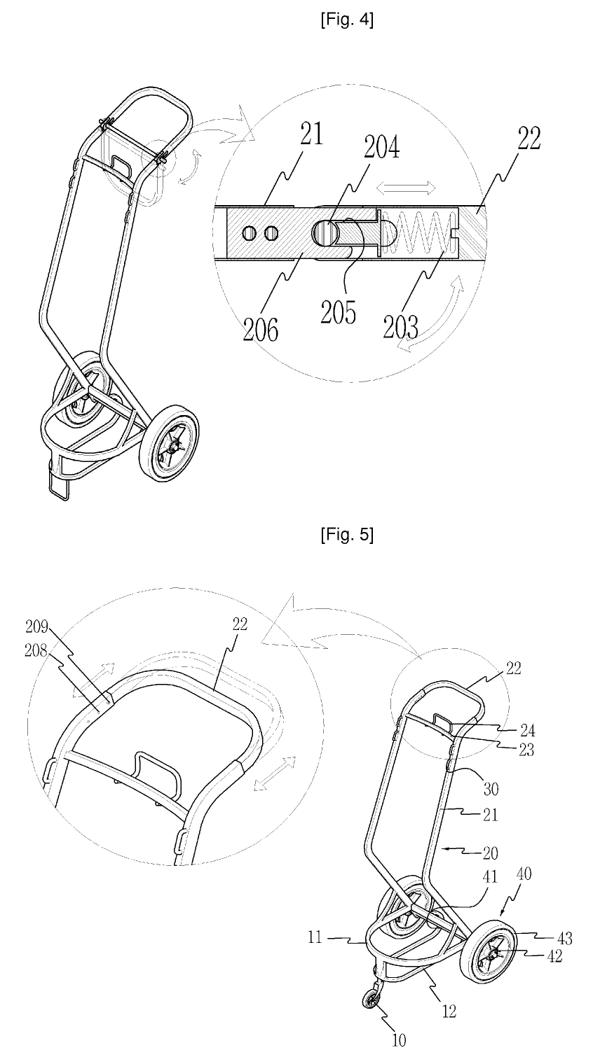

As shown in FIG. 4, the handle 22 of the support unit 20 of the carrier for a golf bag has a moving hole 202. A fixing member 204, which is elastically installed by the spring 203, is provided at the inner side of the moving hole 202 of the handle 22, so that the carrier moves along the moving hole 202. A fixing protrusion 206 having a fixing grove 205 at a center portion is formed at the end of the support member 21 so that the fixing member 204 is inserted and fixed. In addition, the fixing protrusion 206 is inserted into the handle 22.

As shown in FIG. 5, the handle 22 is provided with a fixing ball 207 which is inserted into thesupport member 21 and is elastically supported so that it is protruded from the handle 22. The support member 21 is provided with the fixing hole 208.

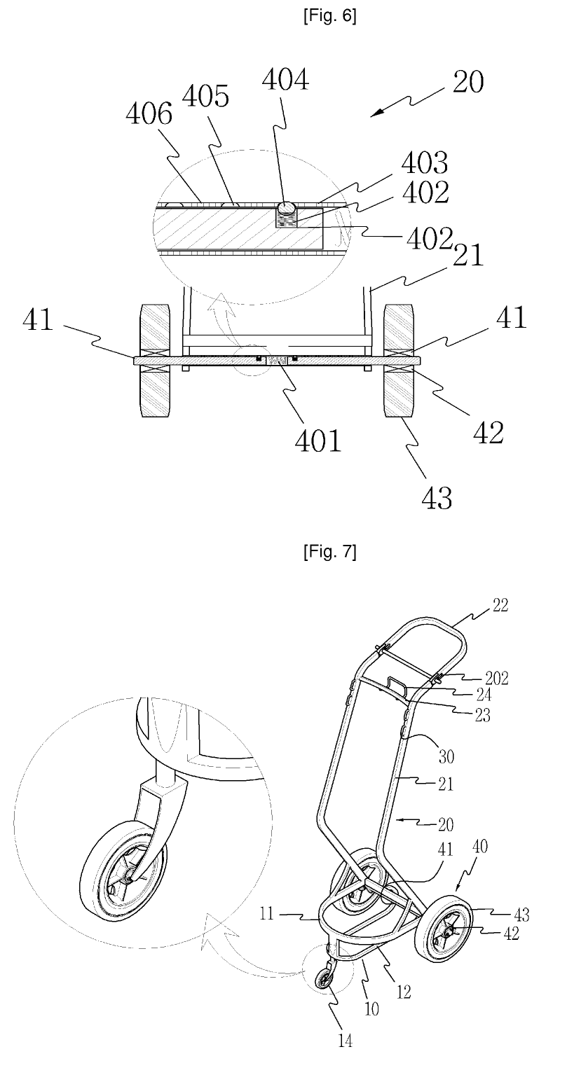

As shown in FIG. 6, in the driving unit 40, a pair of driving shafts 41 are inserted into the support unit 20, and an elastic force spring 403 is formed in the installation groove 402 formed at a center end portion of the driving shaft 41, and a stop ball 404 is formed at an upper side of the elastic force spring 403, and a center end portion of the driving shaft 41 is inserted. A connection rod 406 having a fixing hole 405, into which the stop ball 404 is inserted and fixed, is provided. A buffering spring 401 is installed at an inner side of the driving shaft 41, and the width of the driving wheels 43 of the driving unit is adjusted.

As shown in FIG. 7, the carrier for a golf bag according to the present invention is provided with a caster 14 at an upright member 13 of the mounting unit 10, so that the carrier for a gold bag is moved.

The operation and effects of the present invention will be described.

When a lower side of the golf bag B is mounted on the inner side of the mounting rim 11 of the mounting unit 10, and the mounting member 12 supports the lower side of the golf bag B.

In the above state, in a state that the carrier for a gold bag is tilted while holding the handle 22 formed at the support unit 20, the driving wheels 43 of the driving unit 40 contacts with the ground, and the carrier for the golf bag is dragged and moved.

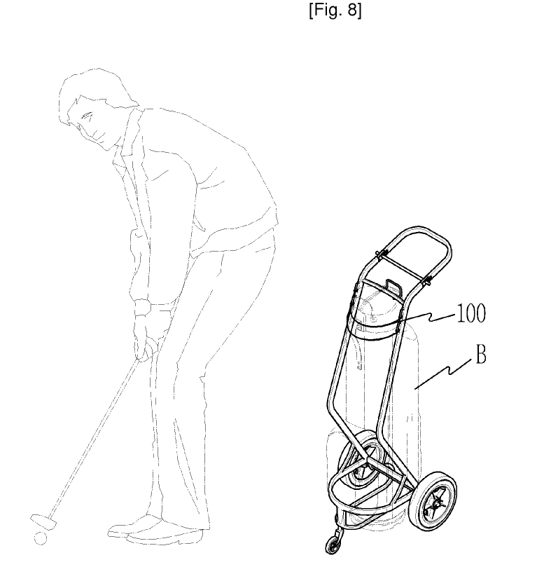

When the golf bag is moved to a destination place, the golf bag B is fixed to the fixing ring 30 formed at the support member 21 so as to prevent the golf bag B from being escaped from the carrier. Here, it is fixed using a fixing stripe 100 as shown in FIG. 8. In case of a golf bag for a woman, since the length of the fixing stripe 100 is short, it is fixed to the lower side via the fixing ring 30.

The carrier can be used in a state that the golf bag B is fixed at the carrier for a golf bag. In a state that the golf bag is stored in the indoor or a golf bag is mounted on the carrier, it is stored on the trunk of the vehicle and is moved.

In a state that the golf bag is mounted on the carrier for a golf bag, the carrier for a golf bag is inputted into the trunk of the vehicle and is moved. So as to store the same in the indoor, the handle 22 protruded from the back surface is folded or inserted, so that it is possible to move or store in a state that the protruded portions are inserted.

So as to fold the handle 22, as shown in FIG. 4, the fixture 204 elastically installed at the moving hole 202 is pulled while overcoming the elastic force of the spring 203, and it is escaped from the fixing groove 205. So, the handle 22 is folded.

In this state, the handle 22 is pulled again, and the fixture 204 formed at a lower side of the fixing protrusion 206 in a circular shape moves along a circular portion of the lower side of the fixing protrusion 206. When the fixture 204 is matched with the fixing groove 205, the fixture 204 is fixedly inserted into the fixing groove 205 based on an elastic force of the spring 203.

According to another embodiment of the handle 22, the handle 22 is inserted into the inner side of the support member 21, so that the length of the handle 22 can be adjusted.

As shown in FIG. 5, the handle 22 pressurizes the handle 22 and pushes the same in a forward direction, and the fixing ball 207 elastically installed at the handle 22 is escaped from the fixing hole 208 formed at the support member 21. So, the handle 22 is inserted into the inner side of the support member 21, and the length of the handle 22 is shortened.

So as to use the handle 22, the handle 22 is pulled forward, and the handle 22 is ejected from the support member 21. When the fixing ball 207 is placed at the fixing hole 208 of the support member 21, the fixing ball 207 is ejected and inserted into the fixing hole 208.

In the carrier for a gold bag, it is needed to increase the intervals of the driving wheels 43 of the driving unit 40 so that the carrier does not fall down in the field.

So as to increase the intervals of the driving wheels 43, the stop ball 404 is pressurized, and the driving shaft 41 is moved outwardly with the elastic force of the buffering spring 401 formed at an inner side of the driving shafts 41. While it is being moved, when the stop ball 404 is matched with the position of the fixing hole 405, the stop ball 404 is escaped from the fixing hole 405 formed at the connection rod 406 and is fixed in a state that the driving wheel 43 is ejected outside, so that the intervals of the driving wheels 43 are adjusted.

In this state, so as to increase the intervals of the driving wheels 43, the driving wheels 43 are pressurized from the outer side, so that the intervals of the driving wheels 43 are adjusted.

The upright member 13 is supported by means of the caster 14, the golf bag may be easily moved without moving the same while tightly holding the handle.

1. A carrier for a golf bag, comprising:
a mounting unit 10 which has a mounting rim 11 for mounting a lower side of a golf bag, a mounting member 12 at a lower surface of the mounting rim 11, and a upright member 13 formed at a front surface of the mounting member 12;
a support unit 20 which is connected with both sides of a back surface of the mounting member 10, thus being connected with a support member 21 and has a handle 22 formed by connecting with an end by bending an upper side of the support member 21 to be parallel with the ground and has a connection member 23 for connecting each support member 21 at a bent portion of the support member 21 and an engaging ring 24 at a center of the connection member;
a fixing ring 30 which is formed at an upper front side of the support member 21 of the support unit 20; and
a driving unit 40 which has a driving shaft 41 at a lower side of the support unit 21 of the support unit 20 and driving wheels having bearings 42 at an outer diameter portion of the driving shaft 41.

2. The carrier of claim 1, wherein a caster 14 is formed at the upright member 13 of the mounting member 10.

3. The carrier of claim 1, wherein said handle 22 of the support unit 20 has a moving hole 202 at the handle member 201, and a fixture 204 which is elastically installed at an inner side of the handle member 201 for thus moving along the moving hole 202 with a spring 203 being disposed, with a fixing protrusion 206, which has a fixing groove 205, being formed at an end of the support member 21 so that the fixture 204 is fixedly inserted, and being inserted into the handle member 201.

4. The carrier of claim 1, wherein said handle 22 is inserted into the support member 21, and a fixing ball 207 elastically protruded from the handle 22 is provided, and a fixing hole 209 is formed at the support member.

5. The carrier of claim 1, wherein in said driving unit 40, a pair of driving shafts 41 are inserted into the support member 20, and an elastic spring 403 is formed at an installation groove 402 formed at a center end of the driving shaft 41, and a stop ball 404 is formed at an upper side of the elastic spring 403, and there is provided a connection rod 406 having a fixing hole 405 into which a center end of the driving shaft 41 and the stop ball 404 are inserted, respectively, and a buffering spring 401 is elastically inserted into an inner side of the driving shaft 41.
